(19) United States
(12) Patent Application Publication
(10) Pub. No.: US 2023/0278751 A1
(43) Pub. Date: Sep. 7, 2023

(54) Forklift Cart Corral

(71) Applicant: Paul James Pagliarulo, Jackson, NH (US)

(72) Inventor: Paul James Pagliarulo, Jackson, NH (US)

(21) Appl. No.: 17/686,036

(22) Filed: Mar. 3, 2022

(51) Int. Cl. B65D 19/00; B65D 19/08

(52) U.S. Cl. CPC B65D 19/0051; B65D 19/0002; B65D 19/08; B62B 3/00

(57) ABSTRACT

A forklift cart corral is disclosed herein. The forklift cart corral is generally a forkliftable platform for carrying carts. The forklift cart corral and the various embodiments described herein may provide an efficient solution for the loading of multiple carts at a time into the rear interior of a box truck, a tractor trailer, or other vehicles having similar functions. Methods of lifting said cart corral are also disclosed herein.

### BACKGROUND

### Technical Field

The present disclosure relates generally to a forklift cart corral. More particularly the present disclosure relates to a forkliftable platform for carrying carts holding items, such as nursery carts holding potted plants.

### Description of Related Art

Carts used for transporting a variety of items are well known in many industries. For example, grocery stores and other retail establishments offer grocery carts to their customers to facilitate the transporting of food and other items during shopping. Similarly, plant nurseries and wholesale plant distributors employ the use of nursery carts for the transporting of potted flowers and other plants. These carts often need to be lifted into box trucks or tractor trailers for long distance transportation. For example, grocery carts may need to be lifted into a tractor trailer when being transported from a grocery cart distributor to a retail store. Similarly, nursery carts containing potted plants may need to be lifted into a tractor trailer when being transported from a plant distributor to a plant nursery.

Current methods of loading carts onto trucks or trailers for long distance transportation suffer from countless issues. These issues include, but are not limited to, the fact that carts are often loaded onto a truck or trailer one or two at a time. In the case of nursery carts holding potted plants, many time plants and pots will fall off and create a mess. There are a countless number of potential solutions to these problems; however, the results of the practical implementation of these potential solutions are uncertain.

Therefore, what is needed is a forklift cart corral having the following characteristics and benefits over the prior art.

### SUMMARY

The subject matter of this application may involve, in some cases, interrelated products, alternative solutions to a particular problem, and/or a plurality of different uses of a single system or article.

In one aspect, a cart corral is disclosed. In this aspect, the cart corral comprises a platform, a base, and at least one railing attached to the top of the platform. The platform defines a surface for receiving at least one cart, and the base is attached to the bottom of the platform. In this aspect, the base also defines a plurality of slots on the front face of the cart corral for engaging with the tines of a forklift.

In another aspect, a tractor trailer comprising a cart corral positioned on the interior of the trailer is disclosed. In this aspect, the cart corral comprises a platform, a base attached to the bottom of the platform, and at least one railing attached to the top of the platform. In this aspect, the platform also defines a surface for receiving at least one cart, and the base also defines a plurality of slots on the front face of the corral for engaging with the tines of a forklift.

In yet another aspect, a method of loading a cart corral into the interior of a tractor trailer is disclosed. In this aspect, the cart corral comprises the platform, and the base attached to the bottom of the platform. Also in this aspect, the method comprises the steps of: (1) providing a forklift having a lift mechanism and a plurality of tines attached to and extending away from the lift mechanism; and (2) lifting the cart corral with the plurality of tines into the interior of the tractor trailer.

It should be expressly understood that the various physical elements of the present disclosure summarized and further disclosed herein may be of varying sizes, shapes, or otherwise dimensions and made from a variety of different materials or methods of manufacture without straying from the scope of the present disclosure.

### BRIEF DESCRIPTION OF THE DRAWINGS

FIG. 1 provides a perspective view of an embodiment of the present disclosure.

FIG. 2 provides a perspective view of an embodiment of the present disclosure engaging with the tines of a forklift.

FIG. 3 provides a perspective view of an embodiment of the present disclosure being lifted by a forklift onto the interior of a trailer.

FIG. 4 provides a perspective view of another embodiment of the present disclosure.

FIG. 5 provides a perspective view of yet another embodiment of the present disclosure.

FIG. 6 provides a perspective view of another embodiment of the present disclosure engaging with the tines of a forklift.

### DETAILED DESCRIPTION

The detailed description set forth below in connection with the appended drawings is intended as a description of presently preferred embodiments of the invention and does not represent the only forms in which the present disclosure may be constructed and/or utilized. The description sets forth the functions and the sequence of steps for constructing and operating the invention in connection with the illustrated embodiments.

Generally, the present disclosure concerns a forkliftable platform for carrying carts. The forkliftable platform may be referred to herein as a “cart corral”. The forklift cart corral and the various embodiments described herein may provide an efficient solution for the loading of multiple carts at a time into the rear interior of a box truck, a tractor trailer, or other vehicles having similar functions. While it is to be expressly understood that the exact dimensions, components, and materials used in the construction of the cart corral are not to be limited by anything contained within this disclosure, in some embodiments, the cart corral may be made from a lightweight metal material. Furthermore, in some embodiments, the carts placed on the corral may also be constructed from lightweight metal materials to facilitate the lifting of said carts once they are placed on the corral. For example, in one embodiment, the lightweight metal material may comprise aluminum.

In most embodiments, the cart corral may generally comprise a platform and a base, wherein the platform may be constructed for receiving a plurality of carts. The base may have a plurality of slots defined on at least one of the faces of the corral for receiving the tines of a forklift. Depending on exact length and width dimensions of the cart corral and the slots defined thereon, the length and width of the tines required to have the appropriate load bearing capacity to lift the corral may vary. Accordingly, in some embodiments, the forklift tines used for lifting the cart corral may be designed specifically for such a task. For example, the forklift tines may have a length greater than or equal to the length of the platform. As will be explained further herein, in some embodiments, the forklift tines may be specially designed for penetrating eyebolts attached to the top of at least one column that may be attached to and extend upwardly away from the platform of the corral.

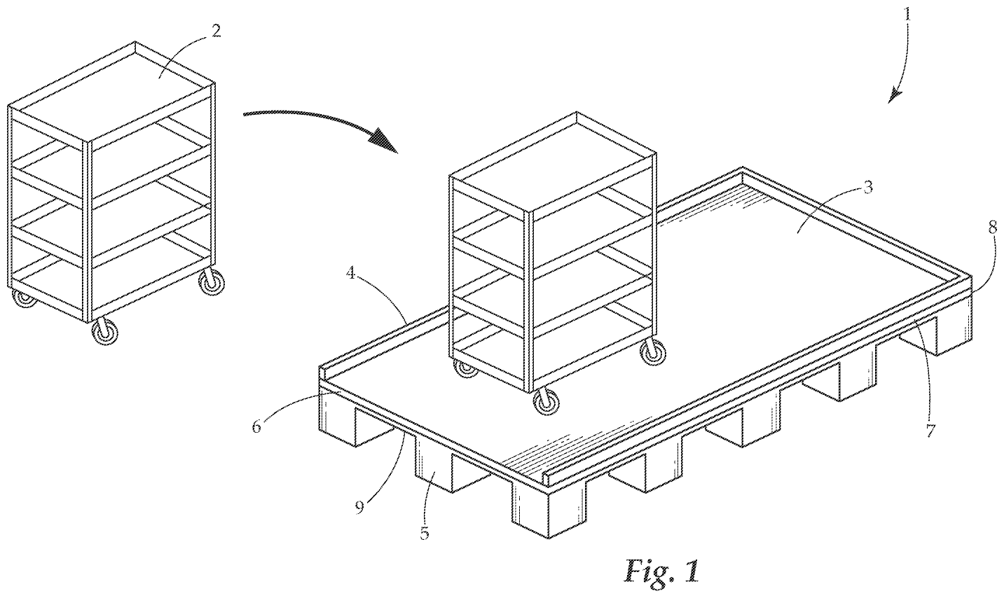

Turning now to FIG. 1, which provides a perspective view of an embodiment of the cart corral 1. In this embodiment, the cart corral 1 comprises a platform 3 connected to a base 5. The platform 3 provides a surface for the placement of one or more carts. For example, in this embodiment, a nursery cart 2 is placed on the platform 3. Furthermore, in this embodiment, the cart corral 1 comprises a plurality of railings 4 connected to the platform 3. The railings 4 prevent the nursery cart 2 from rolling off the platform 3 on the faces of the corral 1 where the railings 4 are attached. For example, in the embodiment shown in FIG. 1, the corral 1 has four faces: a front face 6, a rear face 8, and two side faces 7. In this embodiment, the railings 4 are connected to the two side faces 7 and the rear face 8, so the nursery cart 2 is prevented from inadvertently rolling off the two side faces 7 or the rear face 8 when the corral 1 is being lifted or otherwise moved. Furthermore, in this embodiment, the front face 6 does not comprise a railing for ease of loading and unloading the nursery cart 2 from the corral 1. Finally, in this embodiment, the base 5 defines a plurality of slots 9 for engaging with the tines 12 of a forklift 11. In this embodiment, the slots 9 are defined on each of the faces of the corral 1 to allow the corral 1 to be lifted by a forklift 11 on any of its sides.

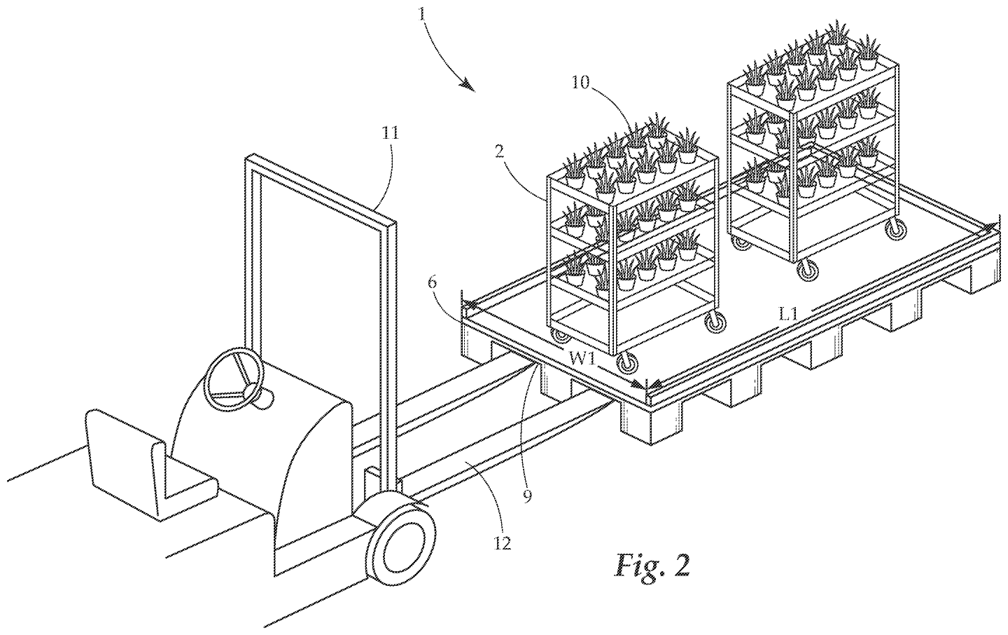

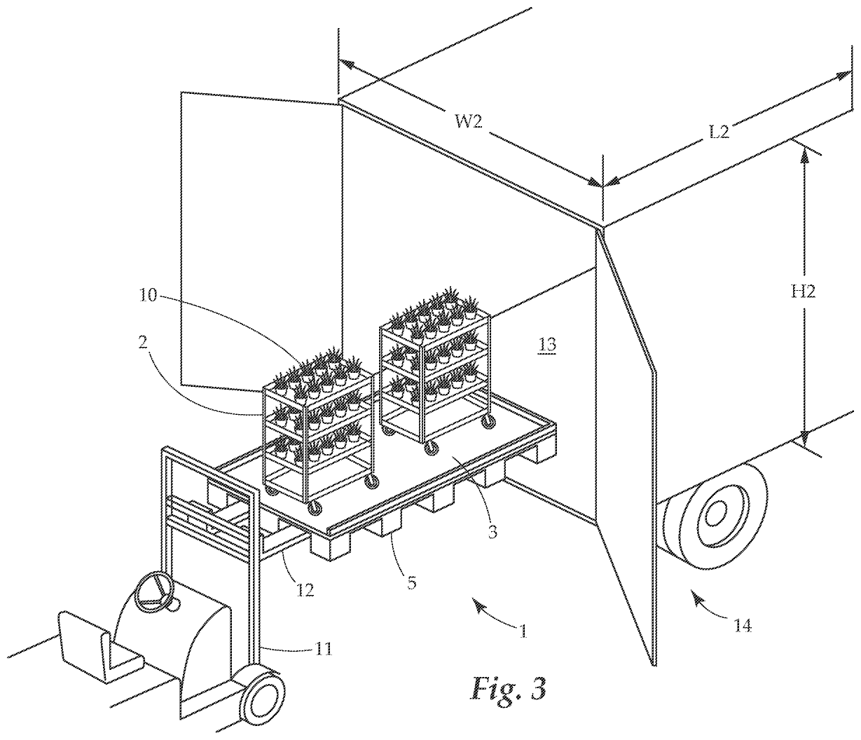

In the embodiment shown in FIG. 2 and FIG. 3, the tines 12 of the forklift 11 are engaging with the slots 9 on the front face 6 of the corral 1. In this embodiment, the slots 9 are sized to allow passage of the tines 12. The corral 1 is holding a plurality of carts 2, which also contain potted plants 10. As shown in FIG. 3, once the tines 12 pass through the slots 9 and are positioned under the base 5, the tines 12 have sufficient load bearing capacity to support the weight of the corral 1 in addition to the carts 2 and the plants 10 that are loaded on the platform 3. In this embodiment, the forklift 11 mechanism is able to lift the corral 1 into the interior 13 of a tractor trailer 14.

Also shown in FIGS. 2 and 3, is the fact that the exact dimensions of the corral 1 are critical to the present disclosure. In particular, in order for the corral 1 to fit inside the trailer 14, the length L1 and width W1 of the corral 1 cannot be greater than the length L2 and width W2 of the interior 13 of the tractor trailer 14. As will be understood by those skilled in the art, the length L2 and width W2 of the interior 13 of a tractor trailer 14 may vary. Accordingly, the exact dimensions of the corral 1 may vary, depending on the embodiment. However, for example, in most cases the interior 13 width W2 of the trailer 14 is one hundred (100) inches (″), and the interior 13 length L2 of the trailer 14 is fifty-three (53) feet (′). Therefore, in the embodiment shown in FIGS. 2 and 3, the width W1 of the corral 1 is less than 100″, and the length L1 of the corral 1 is less than 53′. In a preferred embodiment, the corral 1 is sized to allow four (4) corrals to fit inside the same trailer 14. Accordingly, in a preferred embodiment, the length L1 of each corral is less than 13′3″.

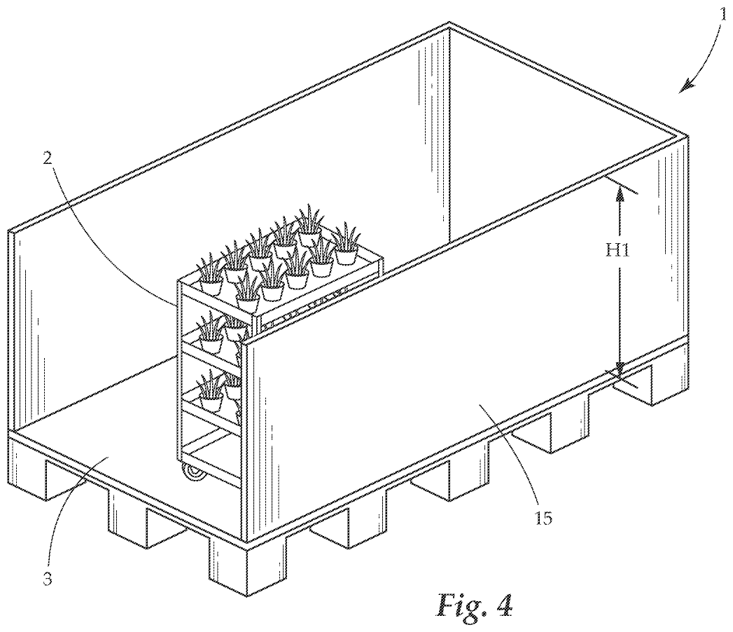

Turning now to FIG. 4, which provides a perspective view of another embodiment of the cart corral 1. In this embodiment, the corral 1 comprises sidewalls 15, which are attached to the platform 3. In this embodiment, the purpose of the sidewalls 15 is similar to the purpose of the railings 4 in previously disclosed embodiments, namely, to prevent the cart 2 from inadvertently rolling or falling off the platform 3 when the corral 1 is lifted or otherwise moved. Also similar to previously disclosed embodiments is the criticality of the height H1 dimensions of the sidewalls 15. For example, in order for the embodiment of the corral 1 having sidewalls 15 to fit inside the trailer 14, the height H1 of each sidewall 15 must be less than the height H2 of the interior 13 of the trailer 14, as shown in FIG. 3. In most cases, the height H2 of the interior 13 of the trailer 14 is 110″, and therefore, in most embodiments, the height H1 of each sidewall 15 is less than 110″. However, in a preferred embodiment, the height H1 of each sidewall 15 is approximately 2′.

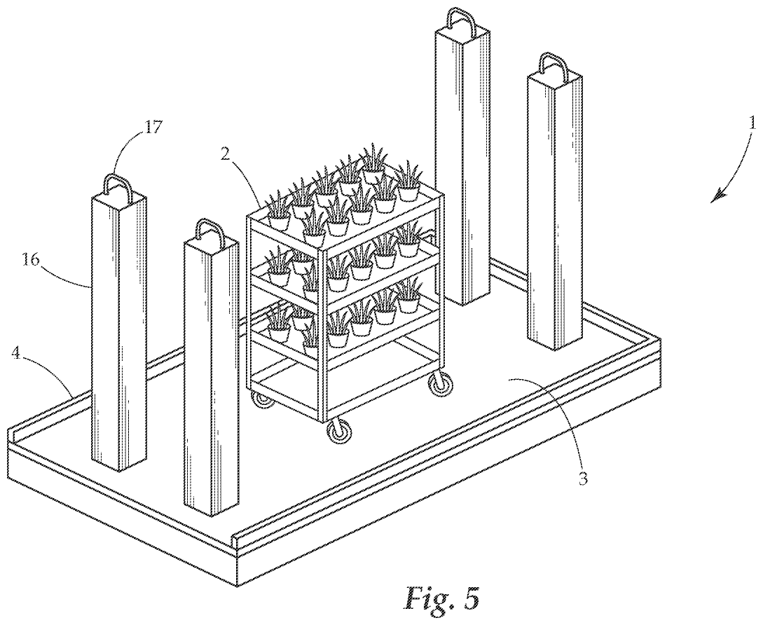

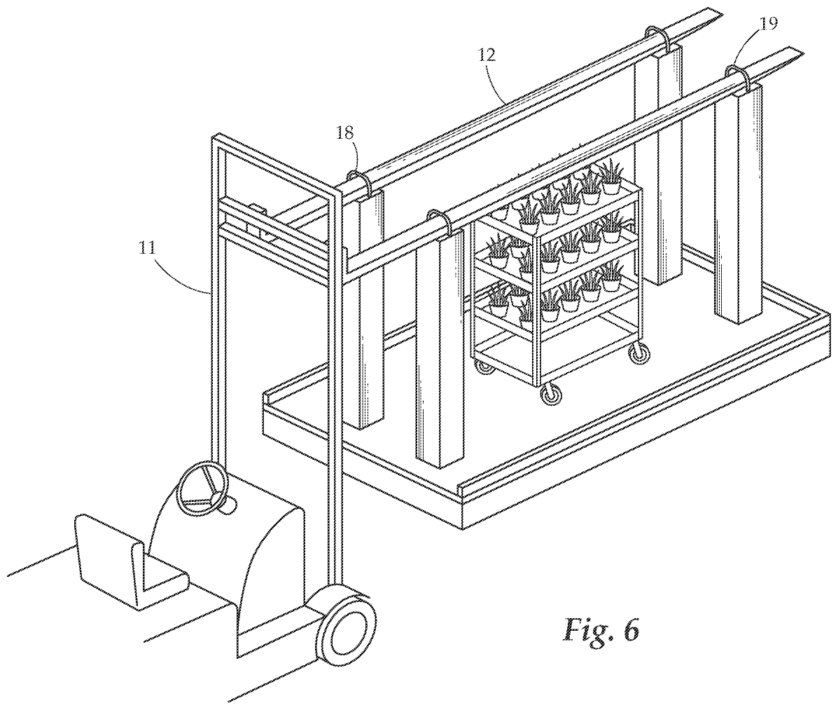

Turning now to FIG. 5, which provides a perspective view of another embodiment of the corral 1. In this embodiment, in addition to the railings 4 meant to prevent the cart 2 from inadvertently rolling off the platform 3, the corral 1 also comprises four columns 16 attached to and extending upwardly away from the platform 3. In this embodiment, each column 16 comprises at least one eyebolt 17 attached to the top of the column 16. As shown in FIG. 6, a first set of eyebolts 18 and a second set of eyebolts 19 each, respectively, share a transverse axis to allow for simultaneous penetration by the tines 12 of a forklift 11. In other words, this embodiment allows for the top lifting of the corral 1, which may be desirable over bottom lifting in certain circumstances.

While several variations of the present disclosure have been illustrated by way of example in preferred or particular embodiments, it is apparent that further embodiments could be developed within the spirit and scope of the present disclosure, or the inventive concept thereof. However, it is to be expressly understood that elements described in one embodiment may be incorporated with any other embodiment in combination with any other elements disclosed herein in the various embodiments. It is also to be expressly understood that any modifications and adaptations to the present disclosure are within the spirit and scope of the present disclosure, and are inclusive, but not limited to the following appended claims as set forth.

What is claimed is:

1. A cart corral comprising:
a platform, the platform defining a surface for receiving at least one cart;
a base attached to a bottom of the platform, the base defining a plurality of slots on a front face of the cart corral; and
at least one railing attached to a top of the platform.

2. The cart corral of claim 1 further comprising the at least one cart placed on the top of the platform.

3. The cart corral of claim 2, wherein the at least one cart is a nursery cart.

4. The cart corral of claim 1 further comprising a plurality of carts placed on the top of the platform.

5. The cart corral of claim 4, wherein at least one of the plurality of carts is a nursery cart.

6. The cart corral of claim 1 further comprising a length and a width, wherein the length of the cart corral is less than fifty-three feet, and the width of the cart corral is less than one hundred inches.

7. The cart corral of claim 6 wherein length of the cart corral is less than thirteen feet and three inches.

8. The cart corral of claim 1 further comprising a plurality of sidewalls attached to the top of platform.

9. The cart corral of claim 8, wherein each one of the plurality of sidewalls comprises a height, the height of each one of the plurality of sidewalls being less than one hundred and ten inches.

10. The cart corral of claim 1 further comprising at least two columns attached to the top of the platform.

11. The cart corral of claim 10, wherein each one of the at least two columns comprises an eyebolt.

12. The cart corral of claim 1 further comprising a lightweight metal material.

13. The cart corral of claim 12, wherein the lightweight metal material comprises aluminum.

14. A tractor trailer comprising a cart corral positioned in an interior of the tractor trailer, the cart corral comprising:
a platform, the platform defining a surface for receiving at least one cart;
a base attached to a bottom of the platform, the base defining a plurality of slots on a front face of the cart corral; and
at least one railing attached to a top of the platform.

15. The tractor trailer of claim 14, wherein the cart corral further comprises the at least one cart placed on the top of the platform.

16. The tractor trailer of claim 14 further comprising a plurality of cart corrals positioned in the interior, wherein each one of the plurality of cart corrals further comprises a plurality of carts placed on a top of each one of the plurality of cart corrals.

17. A method of loading a cart corral into an interior of a tractor trailer, the cart corral comprising:
a platform having a top and a bottom, the platform defining a surface for receiving at least one cart; and
a base attached to the bottom of the platform;
the method comprising the steps of:
providing a forklift, the forklift comprising a lift mechanism comprising a plurality of tines attached to and extending away from the lift mechanism; and
lifting the cart corral with the plurality of tines into the interior of the tractor trailer.

18. The method of claim 17, wherein the base defines a plurality of slots on a front face of the cart corral, the method further comprising the steps of:
engaging the plurality of tines with the plurality of slots; and
lifting the cart corral with the plurality of tines from a bottom of the base.

19. The method of claim 17, wherein the cart corral further comprises four columns attached to and extending upwardly away from the platform, wherein each one of the four columns comprises an eyebolt, the method further comprising the step of lifting the cart corral with the plurality of tines from a top of the cart corral.

20. The method of claim 19, wherein the step of lifting the cart corral with the plurality of tines from the top of the cart corral comprises the steps:
penetrating a first one of the plurality of tines through a first transverse axis shared between a first set of eyebolts attached to a first two of the four columns; and
penetrating a second one of the plurality of tines through a second transverse axis shared between a second set of eyebolts attached to a second two of the four columns.
